(19) United States
(12) Patent Application Publication
(10) Pub. No.: US 2020/0385073 A1
(43) Pub. Date: Dec. 10, 2020

(54) Collapsible Trailer Device

(71) Applicants: Brett Williams, Tuttle, OK (US); Raymond Beard, Blanchard, OK (US)

(72) Inventors: Brett Williams, Tuttle, OK (US); Raymond Beard, Blanchard, OK (US)

(21) Appl. No.: 16/845,585

(22) Filed: Apr. 10, 2020

Related U.S. Application Data
(60) Provisional application No. 62/859,300, filed on Jun. 10, 2019.

(51) Int. Cl. B62D 63/06; B62D 63/08

(52) U.S. Cl. CPC B62D 63/061; B62D 63/08; B62D 63/062

(57) ABSTRACT

The collapsible trailer device includes a central support. The central support has a front end that is defined on an opposing side of a second end. The front end of the central support includes a trailer interface. The rear end of the central support provides an attachment for a rear support via a central support interface. The rear support is removably attachable to the central support and defines a first end opposite a second end. The second end of the rear support includes a rear axle. The rear axle defines a first side and a second side. The first side of the rear axle includes an interface for a first wheel via a first fastener. The second side of the rear axle includes an interface for a second wheel via a second fastener.

### CROSS REFERENCE TO RELATED APPLICATlONS

This application claims the benefit of U.S. Provisional Application No. 62/859,300 filed on Jun. 10, 2019. The above identified patent application is herein incorporated by reference in its entirety to provide continuity of disclosure.

### BACKGROUND OF THE INVENTION

The present invention relates to a collapsible trailer device. More specifically, the present invention provides a solution to the problem of securing certain all-terrain vehicles to a trailer that is easily to set up, utilize and deconstruct.

Many individuals own all-terrain vehicles, utility terrain vehicles or recreational off-highway vehicles for recreational or professional purposes. Typically, all-terrain vehicles (ATVs), utility terrain vehicles (UTVs), and recreational off-highway vehicles (ROVs) are characterized by a motorized vehicle having low-pressure tires, heavy tread tires, enhanced suspension and other features configured to enhance the operation of the vehicle in an off-road setting. Though these vehicles share many similar characteristics, there is a significant amount of variation among them. Some of these vehicles include rollover protection structures, while others do not. Other types of vehicles are defined by a non-straddle seat while others have a straddle seat.

Regardless of the specific combination of features of these vehicles. They are typically not permitted to be operated on certain public roadways. As such, when a user wishes to operate these vehicles, they must first transport these vehicles to an acceptable setting. In order to transport these vehicles, a user must find a suitable trailer for the vehicle. This can be a difficult and inconvenient task for the user. Many trailers are difficult to attach to a vehicle, as trailers are typically large, bulky, heavy and difficult to maneuver by hand.

The act of attaching a trailer to an automobile may, itself, be dangerous. In addition to structural damage that can occur to the automobile and the trailer while the trailer is being attached to the automobile, an improperly attached trailer can cause risks to individuals in the area should it come lose. It also takes time and effort to attach the vehicle to the trailer that is being hauled. Similar consequences and damage can occur from improperly securing the towed vehicle to the trailer.

Currently utilized trailers may be too large for certain types of vehicles or may be too small. Additionally, some trailers, such as flatbed trailers may not provide sufficient support for the vehicle that is secured to the trailer. These types of trailers typically require the use of an intricate system of straps and counterweights.

Therefore, there is a defined need amongst the known art for a system or apparatus that will allow users to safely and effectively secure a vehicle, such as an ATV, a UTV or an ROV to a trailer. The present system should ideally provide the convenience associated with easy assembly and disassembly of the apparatus.

### SUMMARY OF THE INVENTION

In view of the foregoing disadvantages inherent in the known types of trailer and hauling devices and methods now present in the prior art, the present invention provides a collapsible trailer device wherein the same can be utilized for providing convenience for the user when hauling certain types of recreational all-terrain vehicles.

The present system comprises a central support. The central support defines a front end disposed oppositely a rear end. A trailer interface is disposed on the front end of the central support. The trailer interface is configured to engage a trailer, such as via a trailer hitch. A rear support is removably mounted upon the rear end of the central support. The rear support defines a first end opposite a second end. The first end of the rear support comprises a central support interface, configured to attach the rear support to the central support. A rear axle is defined on the second end of the rear support and defines a first side and a second side. A first wheel is removably disposed on the first side of the rear axle. A second wheel is removably disposed on the second side of the rear axle, opposite the first wheel.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the collapsible trailer device in an assembled position.

FIG. 2 shows an exploded view of an embodiment of the collapsible trailer device is a disassembled position.

FIG. 3 shows a perspective view of an embodiment of the collapsible trailer device in use.

### DETAILED DESCRIPTION OF THE INVENTION

Reference is made herein to the attached drawings. Like reference numerals are used throughout the drawings to depict like or similar elements of the collapsible trailer device. The figures are intended for representative purposes only and should not be considered to be limiting in any respect.

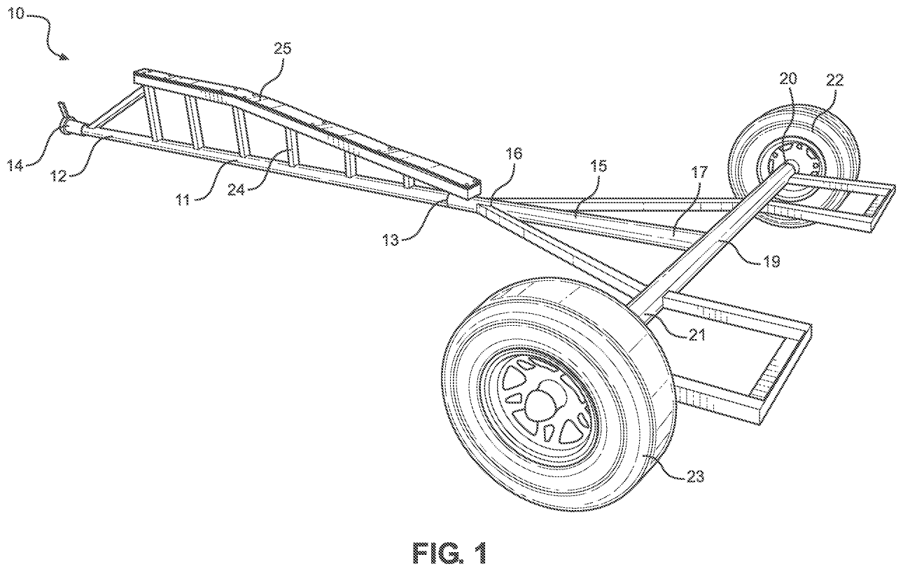

Referring now to FIG. 1, there is shown a perspective view of an embodiment of the collapsible trailer device in an assembled position. The collapsible trailer device 10 comprises a central support 11. The central support 11 defines a front end 12 disposed oppositely a rear end 13. Structurally, the central support 11 is ideally substantially linear in shape. The central support 11 is made of a durable material, such that it can bear the weight of a vehicle being mounted upon the collapsible trailer device 10.

A trailer interface 14 is defined on the front end 12 of the central support 11. The trailer interface 14 is configured to secure the collapsible trailer device 10 to an automobile, such that the automobile may be utilized to tow the collapsible trailer device 10. In the illustrated embodiment, the trailer interface 14 consists of a trailer hitch mount. The trailer hitch mount comprises a trailer coupler configured to engage a trailer ball provided by a ball mount provided on the trailer hitch of the automobile. The trailer interface 14 may further comprise additional attachments, such as a trailer wiring harness or at least one safety chain. In alternate embodiments, alternate configurations may be utilized to secure the collapsible trailer device 10 to the automobile.

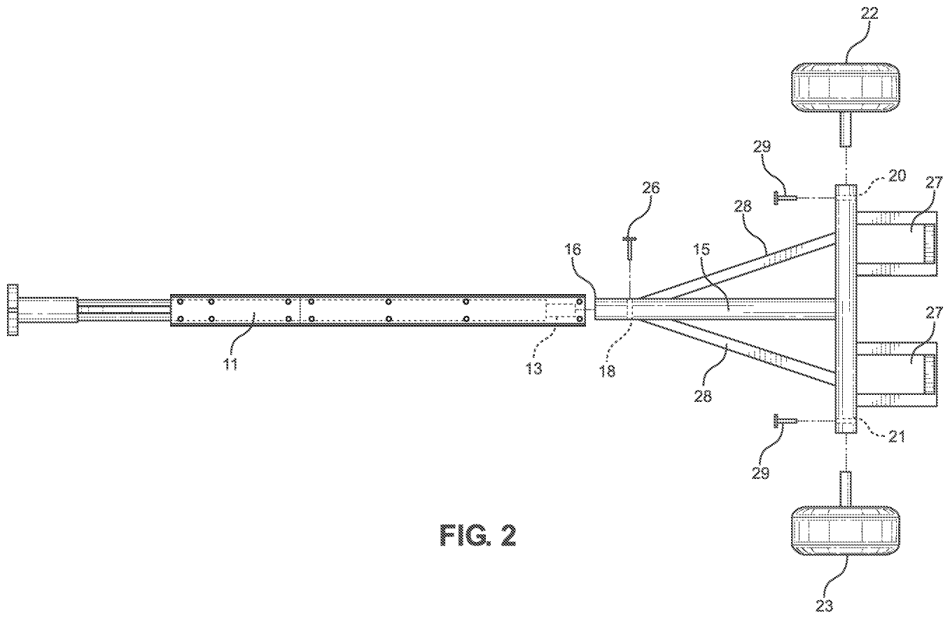

A rear support 15 is removably mounted upon the rear end 13 of the central support 11. The rear support 15 defines a first end 16 disposed oppositely a second end 17. The first end 16 of the rear support 15 defines a central support interface (specifically demonstrated at 18 in FIG. 2). In the illustrated embodiment, the rear support 15 is of an identical perimeter as the central support 11, with the exception of the central support interface. The rear support 15 is made of a durable material, such that it can bear the weight of a vehicle being mounted upon the collapsible trailer device 10.

A rear axle 19 is defined on the second end 17 of the rear support 15, opposite the central support 11. Specifically, the rear axle 19 is perpendicularly mounted on the second end 17 of the rear support 15. The rear axle 19 defines a first side 20 disposed oppositely a second side 21. A first wheel 22 is removably disposed on the first side 20 of the rear axle 19 via a first fastener. A second wheel 23 is removably disposed on the second side 21 of the rear axle 19 via a second fastener. The first wheel 22 and the second wheel 23 are identical in configuration and are configured to allow for movement of the collapsible trailer device 10.

In the illustrated embodiment, the central support 11 defines a spine 24 extending upwardly therefrom. Specifically, in the demonstrated embodiment, the spine 24 defines an arch extending on a top surface of the central support 11. As shown, the spine 24 is ideally of a greater width than the central support 11. Furthermore, a plurality of arch supports is defined between the arch and the central support 11. As such, an elevated surface is provided configured to engage a front end of the vehicle secured to the collapsible trailer device 10. Additionally, in the illustrated embodiment, a bumper 25 is mounted on the top surface of the spine 24. The bumper 25 is made of a material of a lesser density than the spine 24 and is configured to reduce the risk of damage to the vehicle secured to the collapsible trailer device 10.

Referring now to FIG. 2, there is shown an exploded view of an embodiment of the collapsible trailer device is a disassembled position. As illustrated, the first end 16 of the rear support 15 defines a central support interface 18. In the illustrated embodiment, the central support interface 18 consists of a sleeve defined on the first end 16 of the rear support 15 that is configured to receive a rod disposed on the rear end 13 of the central support 11. As such, the rod of the central support 11 may be inserted into the sleeve of the rear support 15, such as to adjoin the central support 11 to the rear support 15. The central support 11 can be secured to the rear support 15 by a fastener. In the illustrated embodiment, the rear support 15 is removably mounted to the rear end 13 of the central support 11 by a pin latch 26. The pin latch 26 is configured to secure through a channel defined by apertures through the central support interface 18.

In the illustrated embodiment, the collapsible trailer device 10 further comprises a pair of wheel openings 27. The pair of wheel openings 27 is configured to receive a pair of wheels of an axle of a vehicle to be secured on the collapsible trailer device 10. As shown, the pair of wheel openings 27 extend outward from the second end 17 of the rear support 15. Specifically, in the illustrated embodiment, the pair of wheel openings 27 are on the same horizontal axis as the central support 11 and the rear support 15. As such, the user will be able to retain the vehicle stowed on the collapsible trailer device 10 at a proper horizontal angle. Furthermore, when the wheels of the vehicle stowed on the collapsible trailer device 10 are placed into the pair of wheel openings 27, the vehicle is further stabilized and secured.

In the illustrated embodiment, the collapsible trailer device 10 further comprises a pair of brackets 28 disposed between the rear axle 19 and the rear support 15. Each bracket of the pair of brackets 28 extends from a medial section of either the first side 20 or the second side 21 of the rear axle 19 to a central section of the rear support 15. As such, force exerted upon the rear axle 19 will be more efficiently dispersed through the entirety of the rear support 15. Furthermore, the pulling force exerted on the rear support 15 will be more evenly dispersed as the collapsible trailer device 10 is towed.

Furthermore, in the demonstrated embodiment, the first wheel 22 and the second wheel 23 are removably securable to the first side 20 and the second side 21 of the rear axle 19 respectively. Specifically, the first side 20 and the second side 21 of the rear axle 19 comprise a pair of pin latch fasteners 29 configured to secure the first wheel 22 and the second wheel 23 to the rear axle 19, such as to enable operation of the collapsible trailer device when the first wheel 22 and the second wheel 23 are engaged with the rear axle. In the illustrated embodiment, the first wheel 22 and the second wheel 23 comprise a wheel rod 30. The pair of wheel rods 30 are configured to engage the first side 20 and the second side 21 of the rear axle 19. In turn the wheel rods 30 can be engaged by the pin latch fasteners 29 to ensure attachment of the first wheel 22 and the second wheel 23 to the rear axle 19.

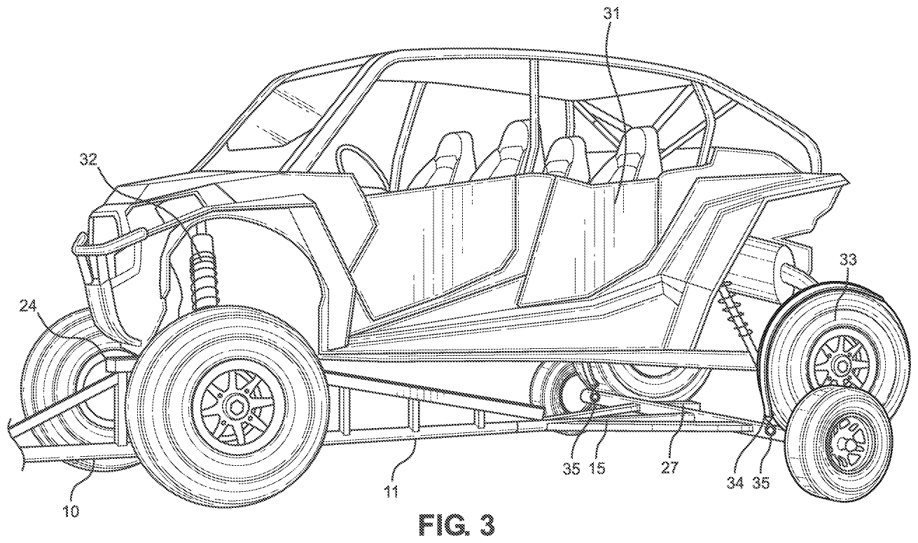

Referring now to FIG. 3, there is shown a perspective view of an embodiment of the collapsible trailer device in use. In use, a vehicle 31 can be affixed to the collapsible trailer device 10. As demonstrated, the front section 32 of the vehicle 31 is secured to the spine 24 disposed on the central support 11. The rear wheels 33 of the vehicle 31 are secured in the wheel openings 27 of the rear support 15. In the demonstrated embodiment, a strap 34 is disposed over each of the rear wheels 33 of the vehicle 31 in order to further secure the vehicle 31 to the collapsible trailer device 10. The strap 34 is secured to a pair of mounting tabs 35 disposed on each side of each wheel opening 27.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A collapsible trailer device, comprising:
a central support;
the central support defining a front end opposite a rear end;
a trailer interface disposed on the front end of the central support;
a rear support removably mounted upon the rear end of the central support;
the rear support defining a first end opposite a second end;
a central support interface defined on the first end of the rear support;
a rear axle defined on the second end of the rear support;
a first wheel removably disposed on the first side of the rear axle via a first fastener;
a second wheel removably disposed on the second side of the rear axle via a second fastener.

2) The collapsible trailer device of claim 1, wherein the central support defines a spine extending upwardly therefrom.

3) The collapsible trailer device of claim 2, wherein the spine of the central support further comprises a bumper mounted on a top surface thereof.

4) The collapsible trailer device of claim 1, wherein the spine of the central support consists of an arch extending on a top surface of the central support and a plurality of arch supports defined between the arch and the central support.

5) The collapsible trailer device of claim 1, wherein the rear axle comprises a pair of wheel openings.

6) The collapsible trailer device of claim 1, wherein a pair of brackets are defined on the rear axle.

7) The collapsible trailer device of claim 1, wherein the trailer interface consists of a trailer hitch mount.

8) The collapsible trailer device of claim 1, wherein the rear support is removably mounted to the rear end of the central support via a pin latch.

9) The collapsible trailer device of claim 1, wherein the first fastener and the second fastener are identical in configuration.

10) The collapsible trailer device of claim 1, wherein the first fastener and the second fastener are pin latch fasteners.

11) The collapsible trailer device of claim 1, wherein the first wheel and the second wheel are rotatably mounted upon a rod, such that the rod can be engaged and disengaged with a sleeve defined on each of the first side and the second side of the rear axle.
